(19) United States
(12) Patent Application Publication
(10) Pub. No.: US 2022/0302639 A1
(43) Pub. Date: Sep. 22, 2022

(54) WATERPROOF CONNECTOR

(71) Applicant: Yazaki Corporation, Tokyo (JP)

(72) Inventors: Masayuki SAITO, Makinohara-shi (JP); Kuniaki NAGATA, Makinohara-shi (JP)

(73) Assignee: Yazaki Corporation, Tokyo (JP)

(21) Appl. No.: 17/699,744

(22) Filed: Mar. 21, 2022

(30) Foreign Application Priority Data
Mar. 22, 2021 (JP) 2021-046819

(51) Int. Cl. H01R 13/52

(52) U.S. Cl. CPC H01R 13/5219

(57) ABSTRACT

A waterproof connector includes a housing that can be fitted to a mating housing, and a packing mounted in the housing that includes a lip which is in close contact with the mating housing. The waterproof connector further includes a protective member that covers the lip of the packing before the housing and the mating housing are fitted to each other.

### CROSS REFERENCE TO RELATED APPLICATION

This application claims benefit of priority under 35 USC 119 based on Japanese Patent Application JP2021-046819 filed Mar. 22, 2021, the entire contents of which are incorporated by reference herein.

### BACKGROUND

### 1. Technical Field

The present invention relates to a waterproof connector.

### 2. Related Art

There is a conventionally known waterproof connector that has a female housing which can be fitted to a male housing. The waterproof connector also includes a seal ring mounted in the female housing that has a lip which is in close contact with the male housing (Japanese Patent Application Publication No. 2015-220169).

The seal ring as a packing is mounted on an outer peripheral surface of a terminal accommodating portion of the female housing serving as a housing. The terminal accommodating portion can be fitted inside a hood of the male housing serving as a mating housing.

After the housing and the mating housing are fitted to each other, the lip of the packing is in close contact with an inner peripheral surface of the hood. The space between the housing and the mating housing is waterproof due to the close contact of the lip of the packing.

### SUMMARY

In the waterproof connector as described above, the lip of the packing is in close contact with the mating housing to waterproof the space between the housing and the mating housing. The lip of the packing is exposed in the state before the housing and the mating housing are fitted to each other.

Therefore, when the housing is handled by itself, for example, when the housing is conveyed, there is a risk that foreign matter such as dust or dirt may adhere to the lip of the packing. If the housing and the mating housing are fitted to each other while foreign matter is adhered to the lip, there is a risk that foreign matter may be interposed between the mating housing and the lip. If foreign matter is interposed between the mating housing and the lip, waterproof performance deteriorates.

The present disclosure has been devised in view of the problems of the related art. An object of the present disclosure is to provide a waterproof connector capable of stabilizing waterproof performance.

A waterproof connector according to the present embodiment includes a housing that can be fitted to a mating housing, and a packing mounted in the housing that includes a lip which is in close contact with the mating housing. A protective member covers the lip of the packing before the housing and the mating housing are fitted to each other.

It is preferable that, when the housing and the mating housing are fitted to each other, the protection of the lip by the protective member is removed by the mating housing.

It is preferable that the protective member is disposed to be movable in a fitting direction and a separation direction of the housing and the mating housing relative to the housing.

It is preferable that, when the housing and the mating housing are fitted to each other, the protective member abuts the mating housing and is moved in the fitting direction of the housing and the mating housing.

It is preferable that an urging member is disposed in the housing, the urging member being for urging the protective member in the separation direction between the housing and the mating housing.

It is preferable that a regulating portion is disposed in the housing, the regulating portion being for regulating movement of the protective member in the separation direction between the housing and the mating housing.

According to the present disclosure, a waterproof connector capable of stabilizing waterproof performance can be provided.

### BRIEF DESCRIPTION OF THE DRAWINGS

FIG. 1 is a cross sectional view of a waterproof connector according to a first embodiment before being fitted to a mating connector;

FIG. 2 is a perspective view showing a part of a waterproof connector according to a first embodiment as a cross section:

FIG. 3 is a perspective view of a packing and a protective member of a waterproof connector according to a first embodiment;

FIG. 4 is an enlarged cross sectional view of a main part of a waterproof connector according to a first embodiment and a mating connector which are in the middle of being fitted together;

FIG. 5 is an enlarged cross sectional view of a main part of a waterproof connector according to a first embodiment and a mating connector which are in the middle of being fitted together;

FIG. 6 is an enlarged cross sectional view of a main part of a waterproof connector according to a first embodiment and a mating connector which have been fitted to each other;

FIG. 7 is a perspective view showing a part of a waterproof connector according to a second embodiment as a cross section;

FIG. 8 is an enlarged view of a main part of FIG. 7;

FIG. 9 is an enlarged cross sectional view of a main part of a waterproof connector according to a second embodiment and a mating connector which have been fitted to each other; and

FIG. 10 is an enlarged cross sectional view of a main part of a waterproof connector according to a second embodiment and a mating connector which are in the middle of being separated from each other.

### DETAILED EMBODIMENT

A waterproof connector according to the present embodiment will be described in detail below with reference to the drawings. The dimensional ratios of the drawings are exaggerated for convenience of explanation and may differ from the actual ratio.

### First Embodiment

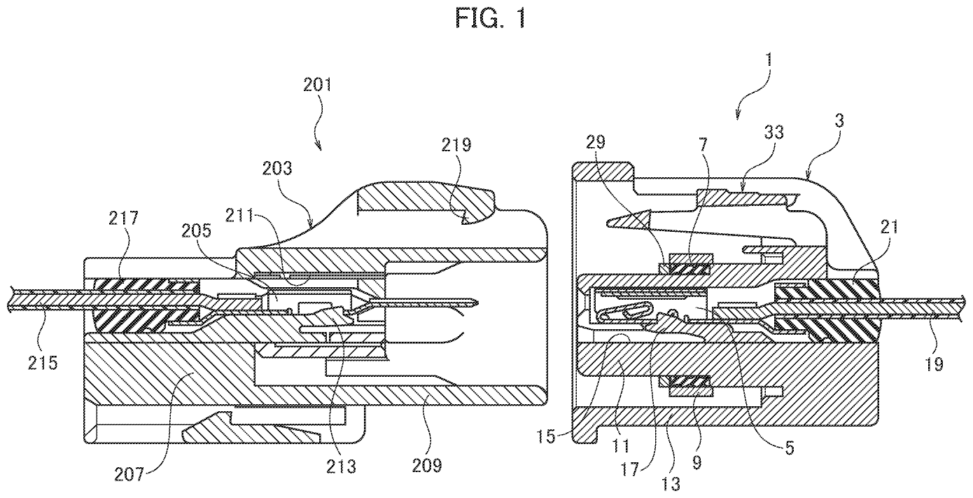

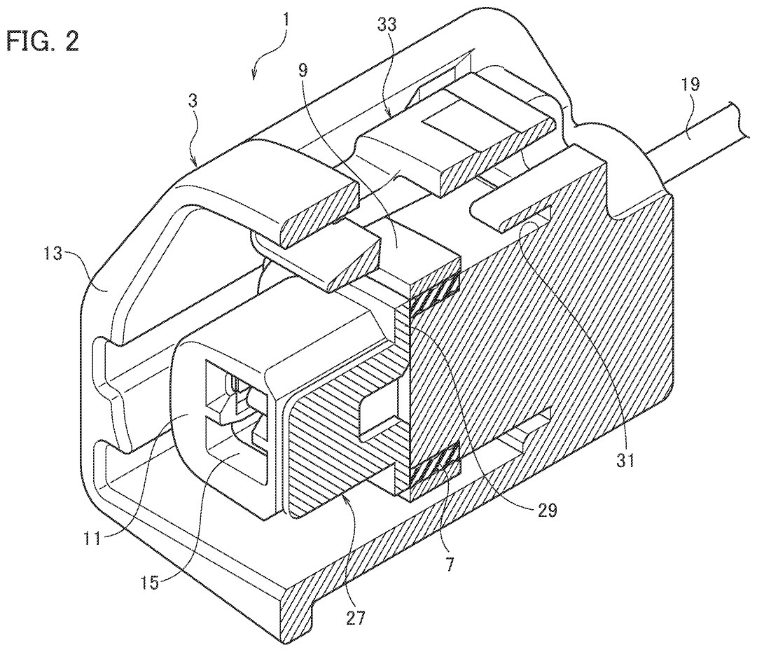

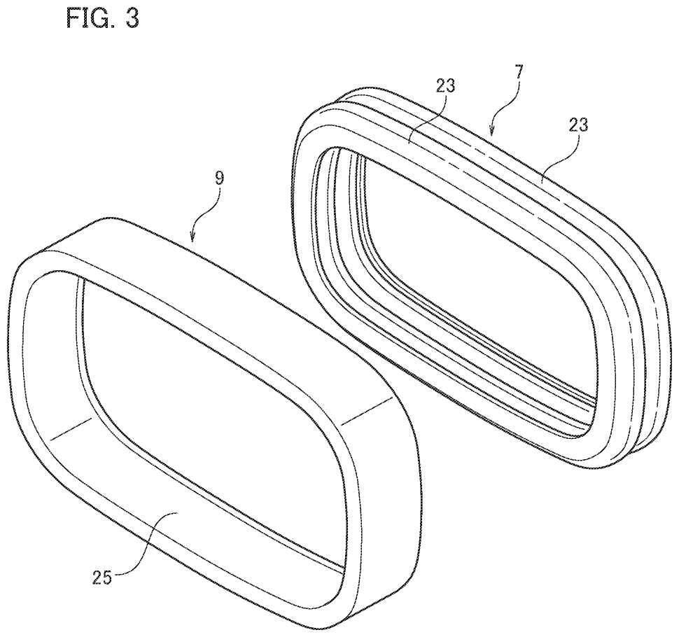

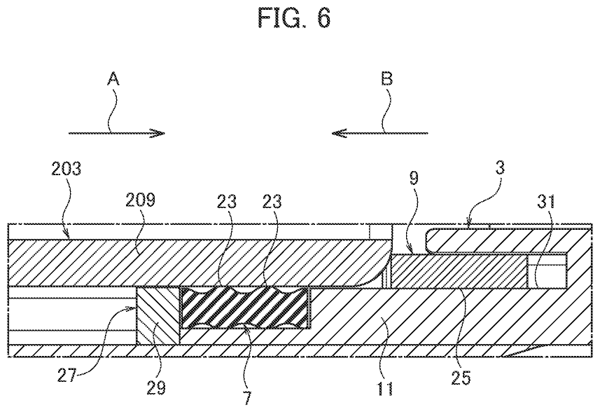

A first embodiment will be described with reference to FIGS. 1 to 6.

As shown in FIG. 1, a waterproof connector 1 of the present embodiment can be fitted to a mating connector 201. The mating connector 201 includes a mating housing 203 and a mating terminal 205.

The mating housing 203 is made of, for example, an insulating material such as a synthetic resin. The mating housing 203 includes a mating main body 207 and a mating hood 209. The mating main body 207 is formed in a housing shape which extends in a fitting direction of the waterproof connector 1 and the mating connector 201. The mating main body 207 has a mating terminal accommodating chamber 211 inside thereof, the mating terminal accommodating chamber 211 being capable of accommodating the mating terminal 205.

The mating terminal accommodating chamber 211 extends along the fitting direction of the waterproof connector 1 and the mating connector 201. A mating locking lance 213 is provided inside the mating terminal accommodating chamber 211 in an elastically deformable manner. The mating locking lance 213 locks with the mating terminal 205 to prevent the mating terminal 205 from coming off from the mating terminal accommodating chamber 211.

The mating terminal 205 is made of a conductive material. The mating terminal 205 is made of, for example, a male terminal that has a tab-shaped connection portion which extends along the fitting direction of the waterproof connector 1 and the mating connector 201. The mating terminal 205 is electrically connected to a terminal portion of a mating wire 215 which is drawn out of the mating terminal accommodating chamber 211.

The mating wire 215 is electrically connected to a power source, a device, or the like, for example. The mating terminal 205 is electrically connected to the terminal portion of the mating wire 215 by means of crimping implemented by press-fastening a press-fastening piece of the mating terminal 205. A mating rubber plug 217 is in close contact with the outer periphery of the mating wire 215.

The mating rubber plug 217 is fixed to the mating terminal 205 together with the mating wire 215 by press-fastening a press-fastening piece of the mating terminal 205. While being fixed to the mating terminal 205, the mating rubber plug 217 is arranged on an opening side of the mating terminal accommodating chamber 211. The outer peripheral surface of the mating rubber plug 217 is in close contact with the inner peripheral surface of the mating terminal accommodating chamber 211 to waterproof the inside of the mating terminal accommodating chamber 211. A tab-shaped connection portion of the mating terminal 205 to which the mating rubber plug 217 is fixed is exposed from the mating terminal accommodating chamber 211 and arranged in the mating hood 209.

The mating hood 209 is formed in a cylindrical shape, the cylindrical shape extending from the mating main body 207 toward the waterproof connector 1 along the fitting direction of the waterproof connector 1 and the mating connector 201. When the waterproof connector 1 and the mating connector 201 are fitted to each other, a main body 11 in a housing 3 of the waterproof connector 1 is fitted inside of the mating hood 209.

As shown in FIGS. 1 to 6, the waterproof connector 1 includes the housing 3, a terminal 5, a packing 7, and a protective member 9.

The housing 3 is made of, for example, an insulating material such as a synthetic resin. The housing 3 includes the main body 11 and a hood 13. The main body 11 extends in the fitting direction of the waterproof connector 1 and the mating connector 201 and is formed in a housing shape capable of fitting inside the mating hood 209. A terminal accommodating chamber 15 capable of accommodating the terminal 5 is provided inside the main body 11.

The terminal accommodating chamber 15 extends along the fitting direction of the waterproof connector 1 and the mating connector 201. A locking lance 17 is provided inside the terminal accommodating chamber 15 in an elastically deformable manner. The locking lance 17 locks with the terminal 5 to prevent the terminal 5 from coming off from the terminal accommodating chamber 15.

The terminal 5 is made of a conductive material. The terminal 5 is made of, for example, a female terminal that has a box-shaped connection portion which extends along the fitting direction of the waterproof connector 1 and the mating connector 201. The terminal 5 is electrically connected to a terminal portion of a wire 19 drawn out of the terminal accommodating chamber 15.

The wire 19 is electrically connected to a power source, a device, or the like, for example. The terminal 5 is electrically connected to the terminal portion of the wire 19 by means of crimping implemented by press-fastening a press-fastening piece of the terminal 5. A rubber plug 21 is in close contact with the outer periphery of the wire 19.

The rubber plug 21 is fixed to the terminal 5 together with the wire 19 by press-fastening a press-fastening piece of the terminal 5. While being fixed to the terminal 5, the rubber plug 21 is arranged on an opening side of the terminal accommodating chamber 15. The outer peripheral surface of the rubber plug 21 is in close contact with the inner peripheral surface of the terminal accommodating chamber 15 to waterproof the inside of the terminal accommodating chamber 15.

When the waterproof connector 1 and the mating connector 201 are fitted to each other, the main body 11 having the terminal accommodating chamber 15 in which the terminal 5 is accommodated is fitted inside of the mating hood 209 of the mating connector 201. After the main body 11 is fitted inside of the mating hood 209, the terminal 5 and the mating terminal 205 are electrically connected to each other. The outer periphery of the main body 11 is covered with the hood 13.

The hood 13 is a member continuous with the main body 11. The hood 13 is formed in a cylindrical shape so as to cover the outer periphery of the main body 11 and extend along the fitting direction of the waterproof connector 1 and the mating connector 201. A fitting space in which the mating hood 209 of the mating connector 201 can be fitted is formed between the inner periphery of the hood 13 and the outer periphery of the main body 11. The packing 7 is housed in the hood 13.

The packing 7 is made of an elastic material such as rubber, for example. The packing 7 is formed in an annular shape such that an inner peripheral surface thereof is in close contact with an outer peripheral surface of a small diameter portion of the main body 11. In the annular shape, the inner diameter of the packing 7 is set to be equal to or slightly smaller than the outer diameter of the small diameter portion of the main body 11. The packing 7 is in close contact with and mounted on the outer peripheral surface of the small diameter portion of the main body 11 in the hood 13. The mounting position of the packing 7 is determined by a step portion formed between the packing 7 and a large diameter portion of the main body 11.

A plurality (in this case, two rows) of lips 23 are continuous in the circumferential direction. The lips 23 are formed on the outer peripheral surface of the packing 7 along the fitting direction of the waterproof connector 1 and the mating connector 201. The plurality of lips 23 are in close contact with the inner peripheral surface of the mating hood 209 when the waterproof connector 1 and the mating connector 201 are fitted to each other. This waterproofs the space between the waterproof connector 1 and the mating connector 201.

The lips 23 of the packing 7 are exposed to the inside of the hood 13 when the waterproof connector 1 is handled by itself, for example, when the waterproof connector 1 is conveyed. Therefore, if foreign matter such as dust or dirt enters the inside of the hood 13, there is a risk that the foreign matter may adhere to the outer peripheral surface of the lips 23. Suppose that the waterproof connector 1 and the mating connector 201 are fitted to each other while foreign matter is adhered to the lips 23. In the above case, the foreign matter is interposed between the mating hood 209 and the lips 23, and the waterproof performance may be deteriorated. Therefore, the lips 23 are protected by a protective member 9 before the waterproof connector 1 and the mating connector 201 are fitted to each other.

The protective member 9 is made of, for example, an insulating material such as a synthetic resin. The protective member 9 is formed in an annular shape having an inner diameter equal to or slightly larger than the outer diameter of the large diameter portion of the main body. The width of the protective member 9 is set to be larger than the width of the plurality of lips 23 so as to be able to cover the outer periphery of the plurality of lips 23. The inner peripheral surface of the protective member 9 is a flat protection surface 25 so as to be in close contact with and brought into contact with the plurality of lips 23.

The protective member 9 is arranged to be movable in a fitting direction A and a separation direction B of the waterproof connector 1 and the mating connector 201 relative to the outer periphery of the main body 11. The protective member 9 is arranged so as to cover the outer periphery of the lips 23 in the state before the waterproof connector 1 and the mating connector 201 are fitted to each other, and the lips 23 are in close contact with and abut the protection surface 25.

By protecting the lips 23 of the packing 7 with the protective member 9, foreign matter does not adhere to the lips 23 when the waterproof connector 1 is handled by itself. This prevents foreign matter from interposing between the mating hood 209 and the lips 23 when the waterproof connector 1 and the mating connector 201 are fitted to each other. Therefore, the waterproof performance between the waterproof connector 1 and the mating connector 201 can be stabilized. The protective member 9 is prevented from falling off from the main body 11 by a regulating member 27.

The regulating member 27 is made of, for example, an insulating material such as a synthetic resin. The regulating member 27 is assembled to the outer periphery of the main body 11. The regulating member 27 has a regulating portion 29 having an outer diameter slightly larger than the outer diameter of the large diameter portion of the main body 11 and the inner diameter of the protective member 9. The regulating portion 29 abuts the protective member 9 to prevent the protective member 9 from falling off from the main body 11. In addition, the regulating portion 29 abuts the packing 7 to prevent the packing 7 from falling off from the main body 11.

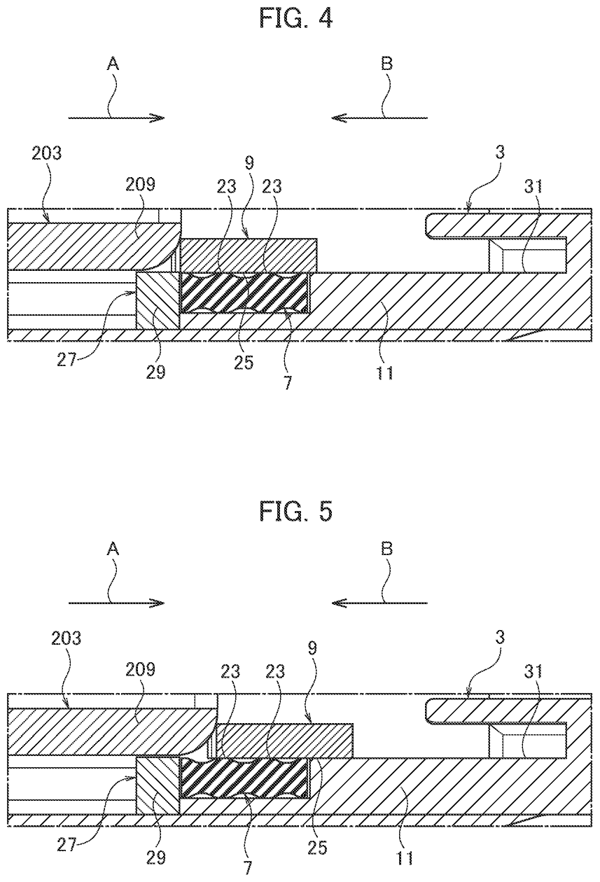

As shown in FIGS. 4 to 6, when the waterproof connector 1 and the mating connector 201 are fitted to each other, the protective member 9 that has abutted the regulating portion 29 of the regulating member 27 abuts a tip surface of the mating hood 209. When the fitting between the waterproof connector 1 and the mating connector 201 progresses, due to the protective member 9 abutting the tip surface of the mating hood 209, the protective member 9 is moved in the fitting direction A.

The protective member 9 is abutting the mating hood 209, and therefore the protective member 9 is moved in the fitting direction A. In accordance with the movement, the lips 23 of the packing 7 are continuously in close contact with and abut the inner peripheral surface of the mating hood 209. After the fitting of the waterproof connector 1 and the mating connector 201 is completed, the lips 23 of the packing 7 are in close contact with the inner peripheral surface of the mating hood 209, and the protective member 9 is housed in a housing portion 31 formed in the housing 3.

The protective member 9 is disposed to be movable in the fitting direction A and the separation direction B relative to the main body 11. This eliminates the necessity to remove the protective member 9 from the main body 11 when the waterproof connector 1 and the mating connector 201 are fitted or separated. Therefore, the handling of the protective member 9 can be simplified. In addition, by regulating the movement of the protective member 9 with the regulating portion 29 and the housing portion 31, the protective member 9 is prevented from falling off from the main body 11.

The mating housing 203 of the mating connector 201 has a locked portion 219. The locked portion 219 can be locked to a lock arm 33 which is provided in the housing 3 of the waterproof connector 1 in an elastically deformable manner. The locked portion 219 and the lock arm 33 are locked with each other when the waterproof connector 1 and the mating connector 201 are fitted to each other. Accordingly, the fitting state of the waterproof connector 1 and the mating connector 201 is maintained. The fitted state of the waterproof connector 1 and the mating connector 201 can be changed to a separated state by elastically deforming the lock arm 33 and releasing the locking between the locked portion 219 and the lock arm 33.

In the waterproof connector 1, the lips 23 of the packing 7 are covered with the protective member 9 in the state before the housing 3 and the mating housing 203 are fitted to each other. This can prevent foreign matter from adhering to the lips 23 when the housing 3 is handled by itself.

Accordingly, in the waterproof connector 1, foreign matter is not interposed between the mating housing 203 and the lips 23, and the waterproof performance can be stabilized.

When the housing 3 and the mating housing 203 are fitted to each other, the protection of the lips 23 by the protective member 9 is removed by the mating housing 203. Therefore, it is not necessary to perform an operation for removing the protection of the lips 23 by the protective member 9 separately from the fitting operation of the housing 3 and the mating housing 203, and workability can be enhanced.

Further, the protective member 9 is arranged to be movable in the fitting direction A and the separation direction B of the housing 3 and the mating housing 203 relative to the housing 3. This eliminates the necessity to remove the protective member 9 from the housing 3 when the housing 3 and the mating housing 203 are fitted or separated. Accordingly, the handling of the protective member 9 can be simplified.

When the housing 3 and the mating housing 203 are fitted to each other, the protective member 9 abuts the mating housing 203 and is moved in the fitting direction A of the housing 3 and the mating housing 203. Therefore, the protective member 9 can be moved in conjunction with the fitting of the housing 3 and the mating housing 203. Accordingly, workability can be enhanced.

### Second Embodiment

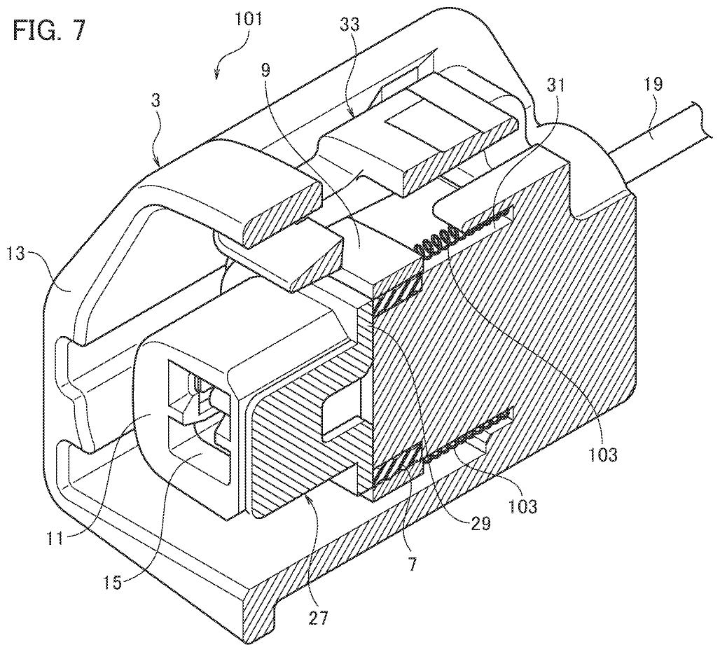

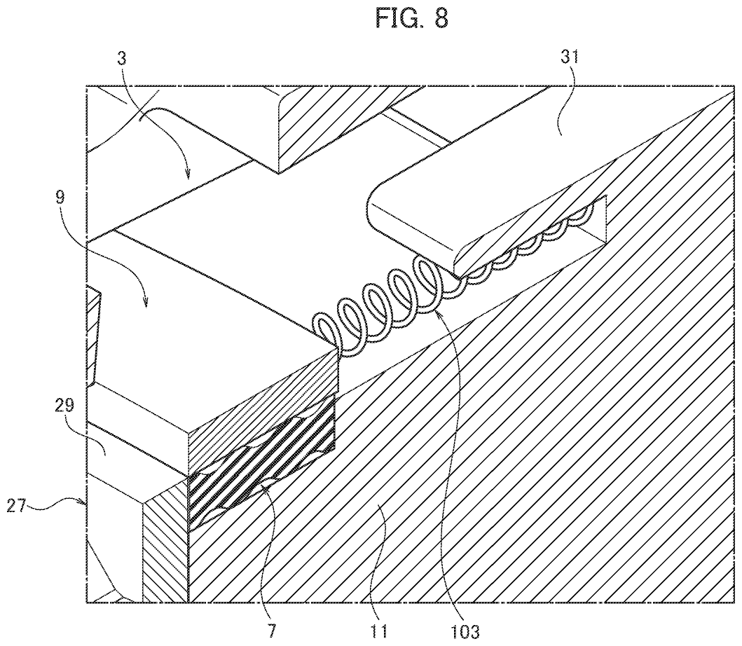

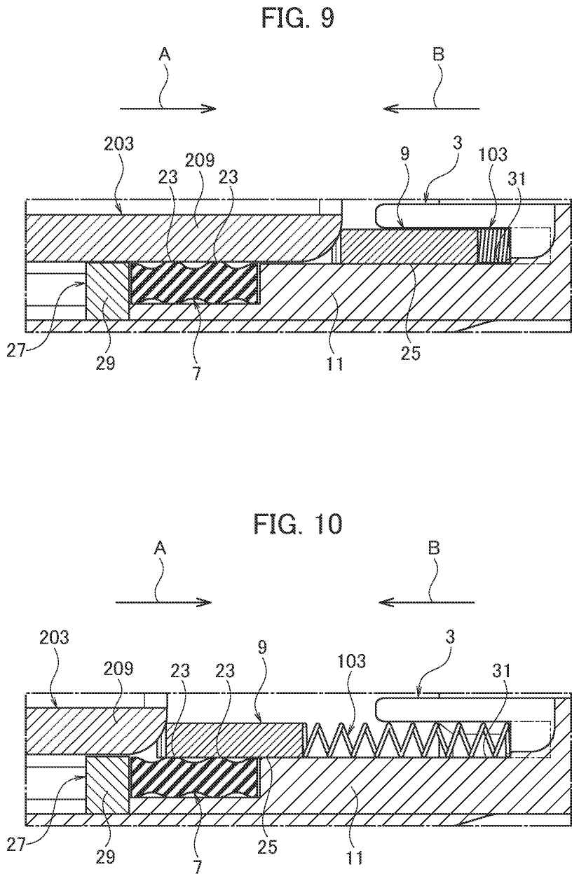

A second embodiment will be described with reference to FIGS. 7 to 10.

Urging members 103 are disposed in a housing 3 of a waterproof connector 101 according to the present embodiment. Each urging member 103 urges the protective member 9 in a separation direction B between the housing 3 and the mating housing 203.

Further, the housing 3 has a regulating portion 29. The regulating portion 29 regulates the movement of the protective member 9 in the separation direction B between the housing 3 and the mating housing 203.

It should be noted that the same reference numerals are used for the same configuration as in the first embodiment. It is assumed that reference can be made to the first embodiment for the explanations of the same configuration and function, and therefore the explanations thereof are omitted. Since the configuration of the second embodiment is the same as that of the first embodiment, effects obtained are the same.

As shown in FIGS. 7 to 10, each urging member 103 is disposed between the protective member 9 and the bottom of the housing portion 31. Each urging member 103 is made of, for example, an elastic member such as a coil spring. A plurality of urging members 103 (two in this case) are arranged at equal intervals in the circumferential direction of the main body 11. Both ends of each urging member 103 abut and are supported by the protective member 9 and the bottom of the housing portion 31 respectively. Each urging member 103 urges the protective member 9 in the separation direction B between the waterproof connector 101 and the mating connector 201 (see FIG. 1).

When the waterproof connector 101 and the mating connector 201 are fitted to each other, each urging member 103 contracts due to the movement of the protective member 9 in the fitting direction A, and is housed in the housing portion 31. When the waterproof connector 101 and the mating connector 201 are separated, each urging member 103 is restored and extended and causes the protective member 9 to move in the separation direction B.

Due to the movement of the protective member 9 by means of the energization of each urging member 103, the lips 23 are in close contact with the protection surface 25 of the protective member 9 such that the protective member 9 protects the lips 23 of the packing 7. Suppose that the protective member 9 is urged in the separation direction B by each urging member 103. In the above case, the lips 23 can be protected by the protective member 9 simultaneously with the separation operation between the waterproof connector 101 and the mating connector 201. Therefore, it is not necessary to perform the operation of moving the protective member 9 separately from the operation of separating the waterproof connector 101 from the mating connector 201. Accordingly, workability can be enhanced. Further, if each urging member 103 urges the protective member 9 in the separation direction B, the protective member 9 presses the mating hood 209. Therefore, the performance of the separation operation between the waterproof connector 101 and the mating connector 201 can be enhanced.

The movement of the protective member 9 in the separation direction B by means of the urging of each urging member 103 is regulated by the regulating portion 29 of the regulating member 27. Suppose that the urging force of each urging member 103 is increased. Even in the above case, the protective member 9 can be stably arranged at the outer periphery of the lips 23 of the packing 7. Therefore, the urging force of each urging member 103 can be easily set, and the degree of freedom in designing each urging member 103 can be enhanced.

Each urging member 103 is disposed in the housing 3 of the waterproof connector 101. Each urging member 103 urges the protective member 9 in the separation direction B between the housing 3 and the mating housing 203. Therefore, the lips 23 can be protected by the protective member 9 simultaneously with the separation operation between the housing 3 and the mating housing 203. Accordingly, workability can be enhanced. Further, it is possible to enhance the performance of the separation operation between the waterproof connector 101 and the mating connector 201.

Further, the housing 3 has the regulating portion 29 which regulates the movement of the protective member 9 in the separation direction B between the housing 3 and the mating housing 203. Therefore, the protective member 9 can be accurately arranged on the lips 23 of the packing 7 without the urging force of each urging member 103. Accordingly, the degree of freedom in designing each urging member 103 can be enhanced.

Although the present embodiment has been described above, the present embodiment is not limited thereto, and various modifications can be made within the scope of the gist of the present embodiment.

The protective member is a member which is movably disposed in a housing, for example, but the protective member is not limited to this. The protective member may be a jelly-like sealing material which is applied so as to cover lips of a packing, for example. In this case, a jelly-like protective member is removed by a mating housing when a housing and the mating housing are fitted to each other. Therefore, even if foreign matter is adhered to the jelly-like protective member, the protective member is removed by the mating housing. Accordingly, the foreign matter is not interposed between the mating housing and the lips.

What is claimed is:

1. A waterproof connector comprising:
a housing that can be fitted to a mating housing;
a packing mounted in the housing, that includes a lip which is in close contact with the mating housing; and
a protective member that covers the lip of the packing before the housing and the mating housing are fitted to each other.

2. The waterproof connector according to claim 1, wherein
when the housing and the mating housing are fitted to each other, protection of the lip by the protective member is removed by the mating housing.

3. The waterproof connector according to claim 1, wherein
the protective member is disposed to be movable in a fitting direction and a separation direction of the housing and the mating housing relative to the housing.

4. The waterproof connector according to claim 3, wherein
when the housing and the mating housing are fitted to each other, the protective member abuts the mating housing and is moved in the fitting direction of the housing and the mating housing.

5. The waterproof connector according to claim 4, wherein an urging member is disposed in the housing, the urging member being for urging the protective member in the separation direction between the housing and the mating housing.

6. The waterproof connector according to claim 5, wherein
a regulating portion is disposed in the housing, the regulating portion being for regulating movement of the protective member in the separation direction between the housing and the mating housing.
